(19) United States
(12) Patent Application Publication
(10) Pub. No.: US 2018/0278565 A1
(43) Pub. Date: Sep. 27, 2018

(54) PHOTO STIMULUS BASED ON PROJECTED GAPS/INTEREST

(71) Applicant: International Business Machines Corporation, Armonk, NY (US)

(72) Inventors: Shadi E. Albouyeh, Raleigh, NC (US); Jeremy A. Greenberger, Raleigh, NC (US); Trudy L. Hewitt, Cary, NC (US); Jana H. Jenkins, Raleigh, NC (US)

(21) Appl. No.: 15/467,528

(22) Filed: Mar. 23, 2017

(51) Int. Cl. H04L 12/58; H04W 4/02; H04L 29/08

(52) U.S. Cl. CPC H04L 51/20; H04W 4/023; G06Q 50/01; H04L 67/22; H04L 51/32

(57) ABSTRACT

A method, system, and computer product for expanding diversity of images uploaded to a network site includes identifying a location of a user device, analyzing social media data corresponding to an area within a threshold distance of the location of the user device, identifying at least one location of interest (LOI) of the area based on an analyzed result of the social media data, determining whether there are one or more image gaps corresponding to the at least one LOI based on the analyzed result of the social media data, and suggesting the user device to take one or more images of the at least one LOI, responsive to a determining that there are the one or more image gaps exist for the at least one LOI.

### FIELD

The present disclosure relates to a technique for enabling users/systems to expand diversity of images uploaded, and more particularly, to a method, system, computer product for suggesting users to take and upload images based on locations of interest (LOIs) or image gaps for the LOIs determined by social interests.

### BACKGROUND

Recently, due to development of social media networks, people are communicating by sharing photos or other digital images via Internet. In particular, when planning for a travel to a specific destination, travelers may review photos related to the destination posted on social media network sites in advance. However, photos are usually posted according to interests of an uploading user and they do not well reflect interests of other internet users. So, in some cases, there may be many duplicate images for the same location, resulting in waste of internet resources.

### SUMMARY

In an aspect of the present disclosure, a system for expanding diversity of images uploaded to a network site is provided. The system includes a processing device and a memory device coupled to the processing device. The processing device is s configured to perform identifying a location of a user device, analyzing social media data corresponding to an area within a threshold distance of the location of the user device, identifying at least one location of interest (LOI) of the area based on an analyzed result of the social media data, determining whether there are one or more image gaps corresponding to the at least one LOI based on the analyzed result of the social media data, and suggesting the user device to take one or more images of the at least one LOI, responsive to determining that there are the one or more image gaps for the at least one LOI.

In an aspect of the present disclosure, a computer-implemented method for expanding diversity of images uploaded to a network site is provided. The method includes identifying a location of a user device, analyzing social media data corresponding to an area within a threshold distance of the location of the user device, identifying at least one LOI of the area based on an analyzed result of the social media data, determining whether there are one or more image gaps corresponding to the at least one LOI based on the analyzed result of the social media data, and suggesting the user device to take one or more images of the at least one LOI, responsive to determining that there are the one or more image gaps for the at least one LOI.

In an aspect of the present disclosure, a computer program product comprising a computer readable storage medium having computer readable program instructions embodied therewith is provided. The computer readable program instructions executable by at least one processor to cause a computer to perform a method for expanding diversity of images uploaded to a network site. The method includes identifying a location of a user device, analyzing social media data corresponding to an area within a threshold distance of the location of the user device, identifying at least one LOI of the area based on an analyzed result of the social media data, determining whether there are one or more image gaps corresponding to the at least one LOI based on the analyzed result of the social media data, and suggesting the user device to take one or more images of the at least one LOI, responsive to determining that there are the one or more image gaps for the at least one LOI.

### BRIEF DESCRIPTION OF THE DRAWINGS

FIG. 1 depicts an example network environment which internet users employ to share digital images according to an exemplary embodiment of the present disclosure;

FIG. 2A depicts an example block diagram of a server according to an exemplary embodiment of the present disclosure;

FIG. 2B depicts an example block diagram of a client device according to an exemplary embodiment of the present disclosure;

FIG. 3 is an example diagram depicting operations of a client device according to an exemplary embodiment of the present disclosure;

FIG. 4 is a diagram depicting example image gaps and corresponding suggestions for a location according to an exemplary embodiment of the present disclosure;

FIG. 5 is an example flow chart depicting a method for expanding diversity of shared digital images according to an exemplary embodiment of the present disclosure;

FIG. 6 is an example flow chart depicting a method for expanding diversity of shared digital images according to an exemplary embodiment of the present disclosure; and

FIG. 7 is a block diagram of a computing system according to an exemplary embodiment of the present disclosure.

### DETAILED DESCRIPTION

Embodiments of the present disclosure will now be described in detail with reference to the drawings. However, the following embodiments do not restrict the invention claimed in the claims. Moreover, all combinations of features described in the embodiments are not necessarily mandatory for the architecture of the present invention. Like numbers are assigned to like elements throughout the description of the embodiments of the present invention.

According to exemplary embodiments of the present disclosure, a method, system, and computer product for expanding diversity of digital images shared among internet users (e.g., social media users). To this end, the method, system, and computer product according to the present disclosure may search existing images for locations in the vicinity of a user and prompt users to take and upload images of the locations if the existing images are not matched with people's interest, demands over Internet. The term “digital images” or “images” include, but are not limited: photos, videos, or the like. In the context of the present disclosure, an exemplary phrase “image(s) for a location” or “image(s) of a location” may be understood to mean image(s) associated with that location, including images of any objects or scenes, such as landmarks, landscapes, attractions, etc., which are taken at that location or taken from other location toward that location.

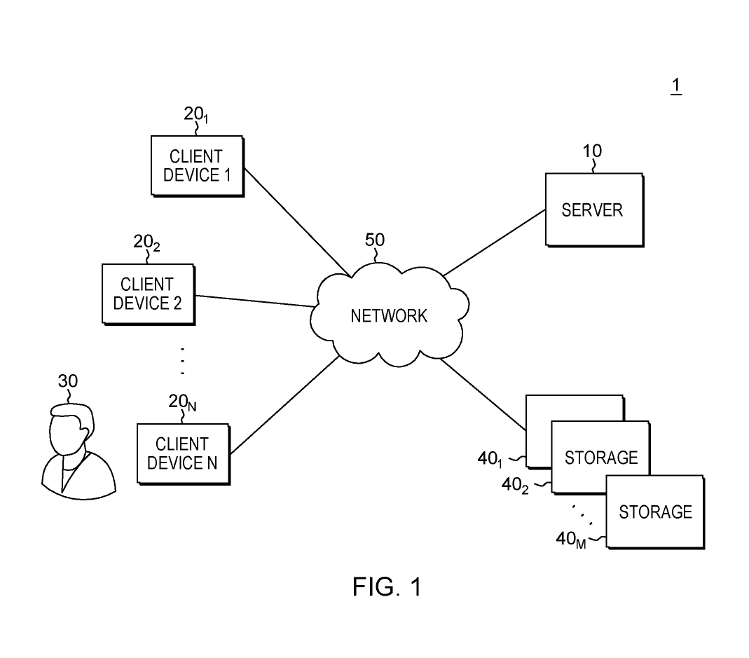

FIG. 1 depicts an example network environment 1 which internet users employ to share digital images according to an exemplary embodiment of the present disclosure.

Referring now to FIG. 1, the network environment 1 may include a server 10, one or more client devices 20₁ to 20_{N}, one or more storage systems, e.g., databases 40₁ to 40_{M}, and a network 50. Here, each of M and N is an integer equal to or greater than one. The network 50 may be configured to support communications among the server 10, the client devices 20₁ to 20_{N}, and the storage systems 40₁ to 40_{M} and may be implemented based on wired communications based on Internet, local area network (LAN), wide area network (WAN), or the like, or wireless communications based on code division multiple access (CDMA), global system for mobile communication (GSM), wideband CDMA, CDMA-2000, time division multiple access (TDMA), long term evolution (LTE), wireless LAN, Bluetooth, or the like.

The server 10 may refer to a network system or platform configured to provide various services such as uploading/sharing/storing of various information or data (e.g., digital images, texts, etc.) collected from the client devices (e.g., 20₁ to 20_{N-1} of FIG. 1) owned or operated by users. To this end, the server 10 may include a framework of hardware, software, firmware, or any combination thereof (not shown), to which, e.g., uploaded information or data can be stored or from which the information or data can be shared with other users. In some embodiments, the server 10 may be a social networking service, or a social network site, etc.

Each client device 20₁ to 20_{N} may refer to any device with the capability to acquire, capture, collect, manipulate, and/or upload various information or data such as digital images, texts, etc.). Examples of such devices include, (but are not limited: an ultra-mobile PC (UMPC), a net-book, a personal digital assistant (PDA), a portable computer, a web tablet, a wireless phone, a mobile phone, a smart phone, an e-book, a portal media player (PMP), a portable game console, a navigation device, a black box, a digital camera, a digital multimedia broadcasting (DMB) player, a digital audio recorder, a digital audio player, a digital picture recorder, a digital picture player, a digital video recorder, a digital video player, or the like, all of which may be connected to the aforementioned network 50.

In one example, a user 30 may refer to an individual who owns or exercises controls over the client device 20_{N}.

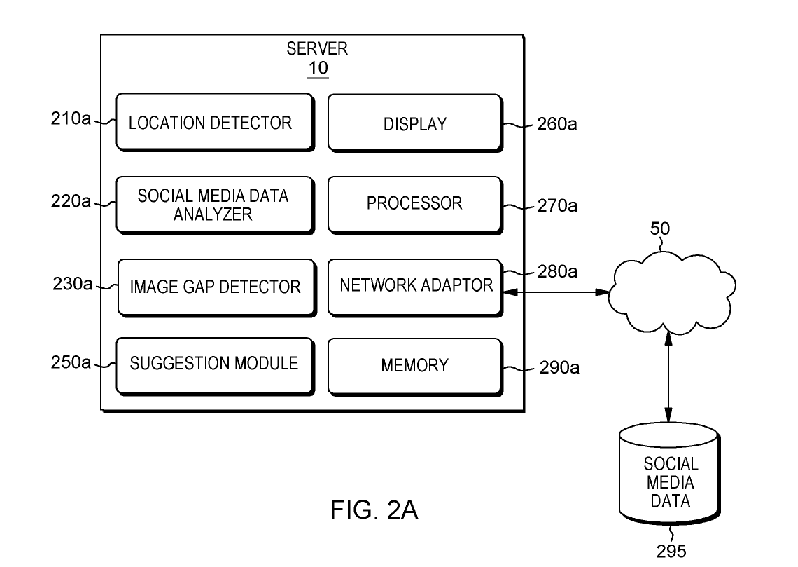

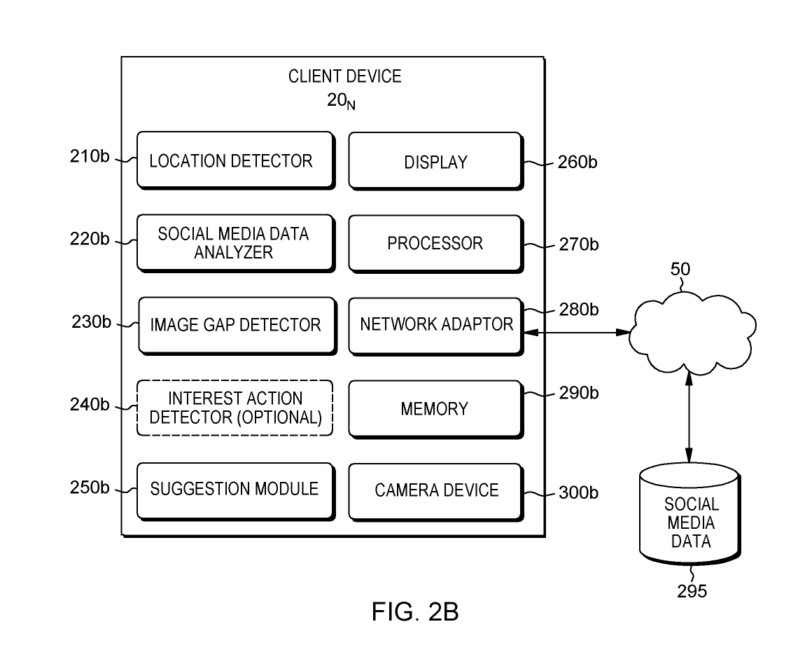

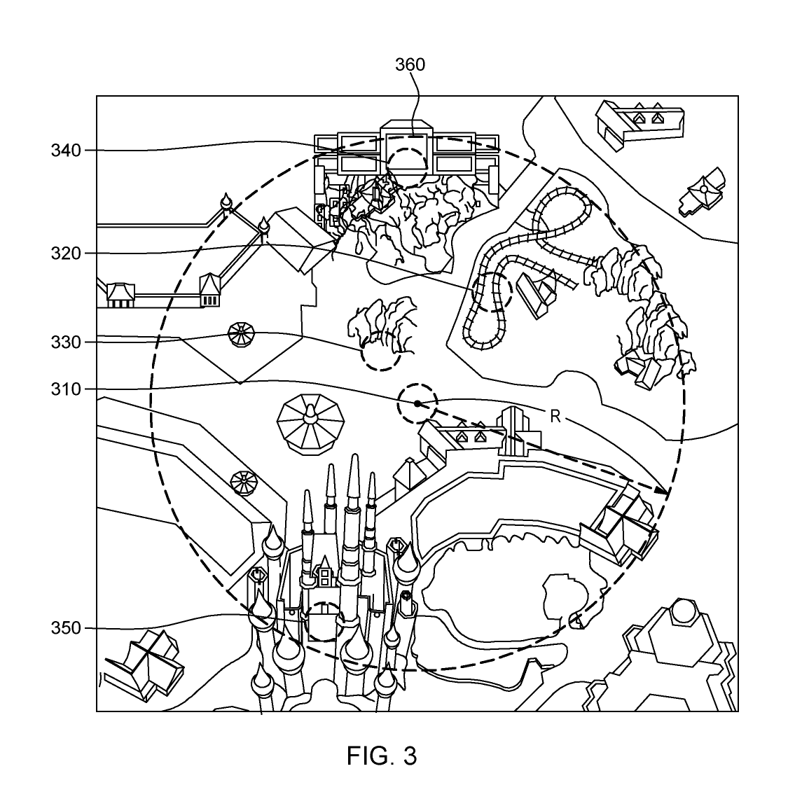

FIG. 2A depicts an example block diagram of a server 10 according to an exemplary embodiment of the present disclosure. FIG. 2B depicts an example block diagram of a client device 20_{N} according to an exemplary embodiment of the present disclosure. FIG. 3 is an example diagram depicting operations of the server 10 or the client device 20_{N} according to an exemplary embodiment of the present disclosure.

As depicted FIG. 2A, the server 10 includes a location detector 210a, a social media data analyzer 220a, an image gap detector 230a, and a suggestion module 250a. The server 10 may further include a display device 260a, a processor 270a, a network adaptor 280a, and a memory 290a.

Referring to the example depicted in FIGS. 2A and 3, if the user 30 travels a place (e.g., Disney) and arrives at a current location 310 (FIG. 3), the location detector 210a of the server 10 may be a component or module that is configured, designed, and/or programmed to identify the current location 310 of the client device 20_{N}. The client 20_{N} may provide a global positioning system (GPS) location (e.g., coordinates) to the location detector 210a of the server 10 via the network 50, and the location detector 210a may detect or identify the current location 310 of the client 20_{N}.

The social media data analyzer 220a may be a component or module that is configured, designed, and/or programmed to analyze social media data 295 associated with the current location 310 (FIG. 3) and/or an area 360 (FIG. 3) within a threshold distance R near the location 310 and provide an analyzed result to the image gap detector 230a. The social media data 295 may be available in the server 10 and/or at least one of the storage systems 40₁ to 40_{M}. The social media data 295 may be provided to the server 10 using the network adaptor 280a via the network 50, as depicted in FIG. 2A. However, exemplary embodiments of the present disclosure are not limited thereto; for example, the social media data 295 may be stored in the memory 290a of the sever 10 and provided to the social media data analyzer 220a. The social media data 295 may refer to social history or any kind of data (or information) (e.g., digital media, images, reviews, comments, demands, requests, inquiries, etc.) uploaded, shared, or posted by internet users via Internet (e.g., social media network sites).

The analyzing of the social media data 295 may allow to identify people's interests in locations (hereinafter is referred to as “locations of interests (LOIs)”) and/or people's interests or demands in information or images (hereinafter is referred to as “social interests”) that they like to see in relation to a particular location.

In some embodiments, a level of social interest may be determined by analyzing users comments for a particular location based on, e.g., a sentiment analysis (also known as opinion mining or emotion artificial intelligence (AI)). For example, the sentiment analysis is one of natural language processing (NLP) techniques that can provide indications from user comments whether users are expressing, e.g., “like”, “dislike”, or “any other emotions”, and to what degree.

For example, the social interests for the particular location may include one or more particular conditions under which images are taken. The particular conditions may include, but are not limited: perspectives from which images are taken (e.g., Cinderella's castle viewed from a Magic Kingdom), times (e.g., seasons, hours, etc.) at which images are taken (e.g., Cinderella's castle in winter, Magic Kingdom at night, etc.). For example, the social media data analyzer 220a may determine if there are one or more LOIs within the area 360, provide the LOIs (if any) within the area 360 and/or social interests for each LOI. In some embodiment, the current location 310 is one of the LOIs.

In some embodiments, in order to determine if a particular location is an LOI, an amount of the social media data 295 associated with the particular location may be compared to a predetermined threshold. For example, the amount of the social media data 295 may be determined using at least of: the number of uploaded images, the number of comments, the number of demands, the number of inquiries, review scores, etc. for the particular location. If the amount of the social media data 295 for that particular location exceeds the predetermined threshold, the social media data analyzer 220a may determine such location as an LOI. Thus, the social media data analyzer 220a may determine one or more LOIs in the area 360 near the client device location 310.

In some embodiments, a scope of the social media data 295 to be collected and/or analyzed may be limited to data (e.g., social history) associated with a particular group of users. In one example, the particular group of users may be formed using the user 30's acquaintances such as friends, family, and/or colleagues, etc. In other example, the particular group of users may be determined based on a degree of closeness to the user 30 (e.g., the degree of closeness may further be determined using a level of connectivity in social media networks). In some embodiments, the number of acquaintances of which social media data are collected and/or analyzed may be limited to a certain number (e.g., five). In other embodiments, a scope of the social media data 295 to be collected and/or analyzed may be limited to data shared/uploaded during a certain time period. For example, social media data uploaded within a recent particular period (e.g., in the last 30 days).

In addition, the image gap detector 230a may be a component or module that is configured, designed, and/or programmed to detect or determine one or more image gaps for each LOI using the analyzed results (e.g., the LOIs and/or the social interests) of the social media data 295 provided by the social media data analyzer 220a. In some embodiments, the image gap detector 230a may determine whether there are one or more image gaps for a particular location (e.g., LOI).

In the context of the present disclosure, the term “image gap” for the particular location is understood to mean a gap between social interests for the particular location and previously uploaded/shared images for the location or in vicinity of the location. As set forth above, the social interests for a location include images (or images taken under particular conditions) at people's interest for that location.

Thus, in one example, if there is no uploaded image available in, e.g., social media network sites for that location, the image gap detector 230a may determine that there exists an image gap between the social interests and the previously uploaded/shared images for that location. In other example, if there are one or more previously uploaded images available in, e.g., social media network sites for that location; but none of the previously uploaded images matches to (or meets) the social interests (e.g., images taken under particular conditions) for that location, then the image gap detector 230a may determine that there exists an image gap between the social interests and the previously uploaded/shared images for that location. As set forth above, the particular conditions may include: perspectives from which images are taken, times at which images are taken, etc.

Thus, in some embodiments, the image gap detector 230a may provide an image gap alert to indicate an existence of one or more image gaps and/or particular contents (or messages) of the image gaps for a certain location to the suggestion module 250a, responsive to determining that the image gaps exist for that location. For example, the particular contents of the image gaps may include: there is no uploaded image for that location; there are some images for that location, but none of the images are taken from a particular perspective or at a particular time.

In some embodiments, the image gap detector 230a may generate no alert if it is determined that no image gap exists for a location; but in other embodiments, the image gap detector 230a may generate other alert to explicitly indicate that no image gap exists for a location.

The suggestion module 250a may be configured, designed, and/or programmed to provide an alert to the user 30 using the client device 20_{N} via the network 50, as depicted in FIG. 1 for prompting to take images of one or more particular locations and/or to upload the images onto, e.g., social media network sites, responsive to a receipt of the image gap alert for that one or more particular locations provided from the image gap detector 230a. If no image gap alert is received from the image gap detector 230a, the suggestion module 250a may generate no alert to the user 30.

In one scenario, when the user 30 arrives at the current location 310, the social media data analyzer 220a may determine that the location 310 is an LOI, the image gap detector 230a may determine an existence of one or more image gaps for the location 310, and the suggestion module 250a may generate an alert to the user 30 via the network 50, such as, e.g., “hey, no photo has been uploaded for this location, please take a photo to upload it”, “hey, people want to see a photo taken in this direction or at night”), for prompting to take and upload images of the location 310.

In other scenario, when the user 30 arrives at the current location 310, the social media data analyzer 220a may determine an existence of one or more LOIs within the area 360 near the location 310, the image gap detector 230a may determine an existence of one or more image gaps for each of the LOIs. The suggestion module 250a may generate an alert to the user 30 via the network 50, such as, e.g., “hey, no photo has been uploaded for these locations which are trending in your network”, for prompting to take and upload images of each of the LOI.

Referring back to the example depicted in FIG. 3, examples LOIs within the area 360 determined by the social media data analyzer 220a are shown with reference numbers 320 to 350. Among the LOIs 320 to 350, LOIs that have been determined to have one or more image gaps are shown with reference numbers 320 and 330 and LOIs that have been determined to have no image gap are shown with reference numbers 340 and 350.

In some embodiments, the suggestion module 250a may be configured to suggest one or more particular conditions (e.g., a perspective from images are taken, a time at which images are taken, a view of a certain location) based on the popularity or trends among social media network sites. For example, if friends of the user 30 have not seen a particular location, the suggestion module 250a may generate an alert to suggest where to take an image based on popular image locations taken by people; for example, the alert may include, but is not limited: “Cinderella's castle has not been viewed by your friends, but we suggest you take a photo from this location based on what is trending on the social media network”.

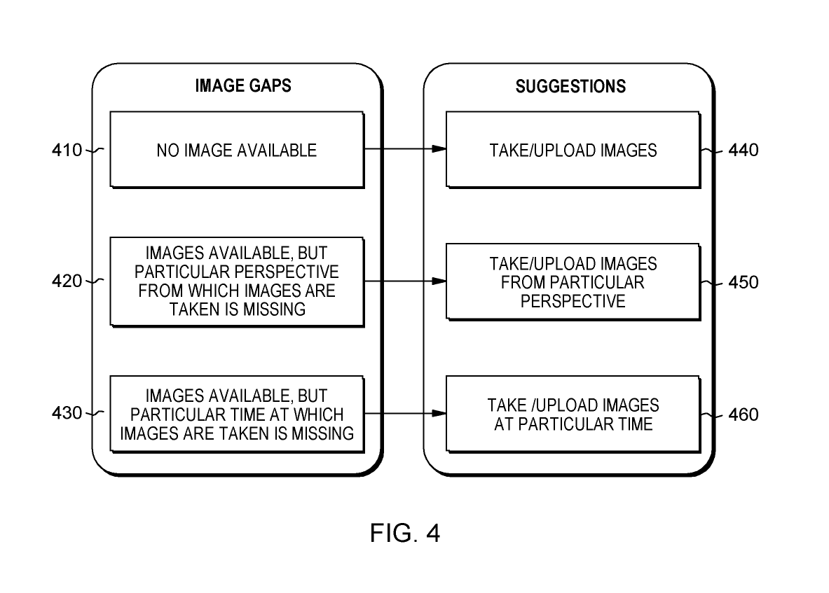

FIG. 4 is a diagram depicting example image gaps and corresponding suggestions for a location according to an exemplary embodiment of the present disclosure.

Referring to the example depicted in FIG. 4, the image gaps for a particular location determined by the image gap detector 230a may include, but are not limited: “no image is available for that location” (410); “images are available for that location, but none of the images has been taken for a particular perspective” (420); and “images are available for that location, but none of the images has been taken at a particular time” (430). In addition, corresponding suggestions made by the suggestion module 250a are depicted with reference numbers 440 to 460 in FIG. 4. If the image gap of “no image is available for that location” (410) is determined, the suggestions will be, e.g., “take and upload images” (440). In this case, particular conditions such as a perspective or time from/at which images should be taken can also be suggested, based on the social interests (e.g., trends or a level of popularity among users over social media networks) provided by the social media data analyzer 220a. Further, if the image gap of “none of the images has been taken for a particular perspective” (420) is determined, the suggestions will be, e.g., “take images from the particular perspective and upload the images” (450). Next, if the image gap of “none of the images has been taken at a particular time” (430) is determined, the suggestions will be, e.g., “take images at the particular time and upload the images” (460).

In some embodiments, one or more of the location detector 210a, the social media data analyzer 220a, the image gap detector 230a, and the suggestion module 250a may be implemented using a hardware processor (e.g., 270a of FIG. 2A) or based on a field-programmable gate array (FPGA) design (not shown), but in other embodiments, they may be implemented based on program codes which are stored in a memory (e.g., 290a of FIG. 2A) or in the hardware processor, and executed by the hardware processor.

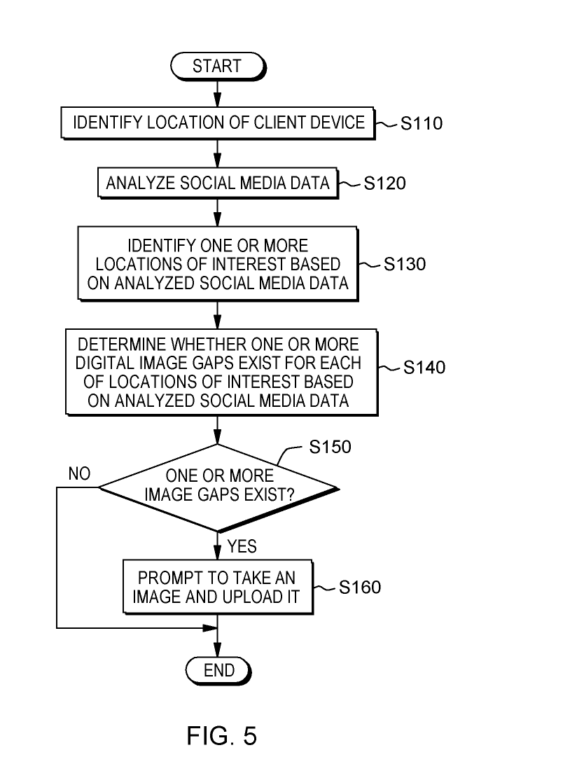

FIG. 5 is an example flow chart depicting a method for expanding diversity of shared digital images according to an exemplary embodiment of the present disclosure.

Referring to the example depicted in FIGS. 2A and 3-5, the method may include steps S110 to S160.

At S110, the location detector 210a may identify a location of the client device 20_{N}. Next, the social media data analyzer 220a may analyze social media data (e.g., 295 of FIG. 2A) associated with an area (e.g., 360 of FIG. 3) near the client device location (e.g., 310 of FIG. 3) (S120) and identify one or more LOIs (e.g., 320 to 350 of FIG. 3) within the area based on analyzed results of the social media data (S130).

Next, at S140 and S150, the image gap detector 230a may determine if there are one or more image gaps for each of the LOIs (e.g., 320 to 350 of FIG. 3) based on the analyzed results of the social media data. If there are one or more image gaps for particular LOIs (e.g., 320 and 330 of FIG. 3) (YES), the suggestion module 250a may prompt to take images of the LOIs with the image gaps and upload the taken images and the method ends (S160). In S160, the suggestion module 250a may generate an alert for prompting to take and upload the images and display the alert on a display (e.g., 260b of FIG. 2B) of the client device 20_{N}. Referring still to FIG. 5, in one embodiment, if there is no image gap for all the LOIs within the area (e.g., 360 of FIG. 3) (NO), the method ends or ends while suggesting not to take and/or upload images (not shown).

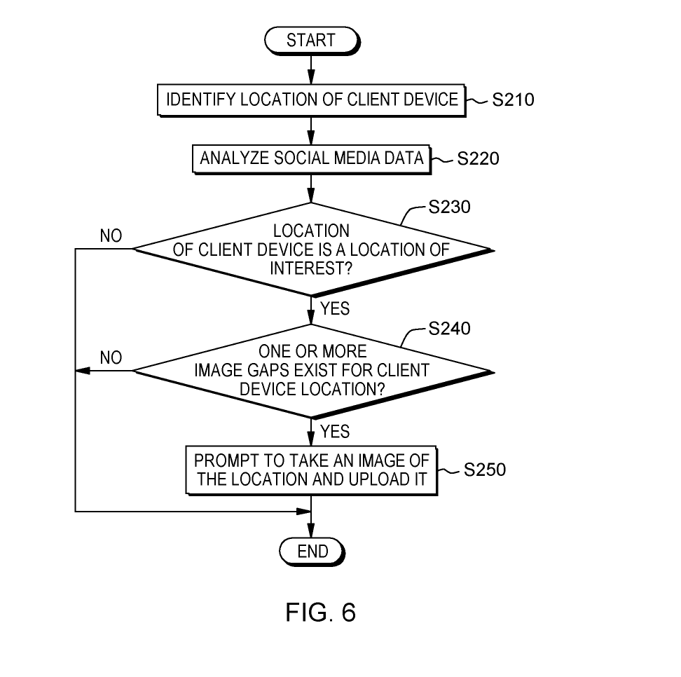

FIG. 6 is an example flow chart depicting a method for expanding diversity of shared digital images according to an exemplary embodiment of the present disclosure.

Referring to the example depicted in FIGS. 2A, 3, 4 and 6, the method may include steps S210 to S250.

At S210, the location detector 210a may identify a location of the client device 20_{N}. Next, the social media data analyzer 220a may analyze social media data (e.g., 295 of FIG. 2) associated with the client device location (e.g., 310 of FIG. 3) or in the vicinity of the client device 20_{N} (S220), and determine if the client device location is an LOI based on an analyzed result of the social media data (S230).

If it is determined that the client device location is an LOI (YES), the image gap detector 230a may determine if there are one or more image gaps for the client device location based on the analyzed result of the social media data (S240). If it is determined that the client device location is not an LOI (NO), the method ends. In addition, if it is determined that there are one or more image gaps for that location (YES), the suggestion module 250a may prompt to take images of the location and upload the taken images (S250). In S250, the suggestion module 250a may generate an alert for prompting to take and upload the images and display the alert on a display (e.g., 260b of FIG. 2B) of the client device 20_{N}. In one embodiment, if there is no image gap for that location (NO), the method ends or ends while suggesting not to take and/or upload images (not shown).

Although it is illustrated in FIGS. 2A and 3-6 that the location detector 210a, the social media data analyzer 220a, the image gap detector 230a, and the suggestion module 250a are implemented in the server 10 and the operations thereof are performed by the server 10. However, exemplary embodiments of the present disclosure are not limited thereto. In some embodiments, functions of one or more of the location detector 210a, the social media data analyzer 230a, the image gap detector 230a, and the suggestion module 250a may be implemented in the client device 20_{N}, and one or more of the aforementioned operations of the sever 10 may be performed by the client device 20_{N}.

Referring to the example of FIG. 2B, the client 20_{N} includes a location detector 210b, a social media data analyzer 220b, an image gap detector 230b, and a suggestion module 250b. The client 20_{N} may further include a display device 260b, a processor 270b, a network adaptor 280b, and a memory 290b. Each of the location detector 210b, the social media data analyzer 220b, the image gap detector 230b, and the suggestion module 250b of FIG. 2B have substantially the same functions or operations to a corresponding one of the location detector 210a, the social media data analyzer 220a, the image gap detector 230a, and the suggestion module 250a of FIG. 2A. Thus, duplicate descriptions thereof will be omitted for simplicity. The social media data 295 may be available in the server 10 and/or at least one of the storage systems 40₁ to 40_{M} and may be provided to the client device 20_{N} using the network adaptor 280b via the network 50, as depicted in FIG. 2B.

In addition, the client 20_{N} may further include an interest action detector 240b and a camera device 300b. The interest action detector 240b may be a component or module that is configured, designed, and/or programmed to detect the user 30's interest actions such that the user 30 is interested in sharing images with other users or is about to take images. For example, the user's interest actions may include, but are not limited: opening a camera application to take images; a liking of relevant social media page of a certain location (e.g., a location of the client device 20_{N}); contextual indication (e.g., a text message that says “I love this place”); a social media post that checks in at a certain location, etc.

In some embodiments, if the interest action detector 240b detects one or more interest action by the user 30 at a location and the image gap detector 230b has not provided an image gap alert for that location or has provided an alert indicating that no image gap exists, then the suggestion module 250b may provide an alert to the user 30 for discouraging to take and/or upload images, so preventing duplicate images of the same location, perspective, and/time from being uploaded.

In some embodiments, if there are images taken by friends of the user 30, the client device 20_{N} may be configured to present the user 30 with the images, they thus could share the images directly, rather than uploading the images to, e.g., social media network sites.

In a particular embodiment, the location detector 210b, the social media data analyzer 220b, the image gap detector 230b, the interest action detector 240b, and the suggestion module 250b are implemented based on a social media application (APP) (not shown). For example, the social media APP may be programmed to share images/reviews with other users for interesting locations and may be installed on the client device 20_{N}. Further, the social media APP may detect a location (e.g., 310 of FIG. 3) of the client device 20_{N}, analyze social media data (e.g., 295 of FIG. 2B) for that location, detect one or more image gaps (e.g., there is no uploaded image for that location; or a particular perspective or time from/at which images are taken for that location, based on analyzed results of the social media data. Next, the social media APP may push a prompt to take images of that location to fill the detected image gaps and upload the images. However, in other aspects, upon detecting the location, the social media APP may analyze social media data for an area (e.g., 360 of FIG. 3) near the client device location (e.g., 310 of FIG. 3), determine locations of interests (LOIs) (e.g., 320 to 350 of FIG. 3) within the area, detect image gaps for one or more (e.g., 320 and 330 of FIG. 3) of the LOIs, and push a prompt to take images of the one or more of the LOIs to fill the detected image gaps and upload the images. In some embodiments, the social media APP may detect the user 30's interest actions after the operation of analyzing the social media data and push a prompt to take and upload the images, upon detecting the user 30's interest actions.

In some embodiments, one or more of the location detector 210b, the social media data analyzer 220b, the image gap detector 230b, the interest action detector 240b, and the suggestion module 250b may be implemented using a hardware processor (e.g., 270b of FIG. 2B) or based on a field-programmable gate array (FPGA) design (not shown), but in other embodiments, they may be implemented based on program codes (e.g., application (APP)) which are stored in a memory (e.g., 290b of FIG. 2B) or in the hardware processor, and executed by the hardware processor.

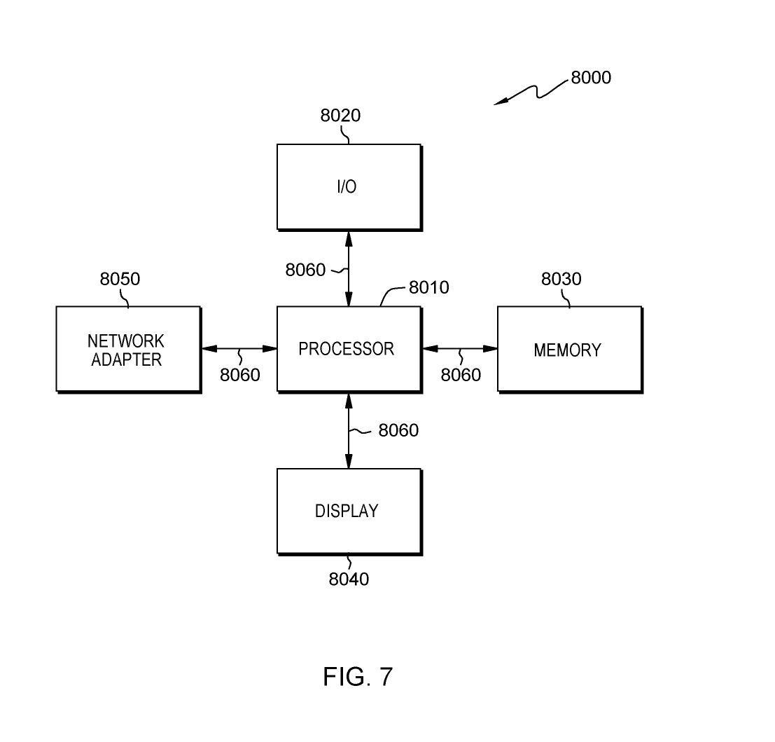

FIG. 7 is a block diagram of a computing system 8000 according to an exemplary embodiment of the present disclosure.

Referring to the example depicted in FIG. 7, a computing system 8000 may be used (without limitation) as a platform for performing (or controlling) the functions or operations described hereinabove with respect to the client device 20_{N} or the server 10 of FIGS. 1, 2A and 2B, and/or methods of FIGS. 5 and 6.

In addition (without limitation), the computing system 8000 may be implemented with an UMPC, a net-book, a PDA, a portable computer, a web tablet, a wireless phone, a mobile phone, a smart phone, an e-book, a PMP, a portable game console, a navigation device, a black box, a digital camera, a DMB player, a digital audio recorder, a digital audio player, a digital picture recorder, a digital picture player, a digital video recorder, a digital video player, or the like.

Referring now specifically to FIG. 7, the computing system 8000 may include a processor 8010, I/O devices 8020, a memory system 8030, a display device 8040, bus 8060, and a network adaptor 8050.

The processor 8010 is operably coupled to and may communicate with and/or drive the I/O devices 8020, memory system 8030, display device 8040, and network adaptor 8050 through the bus 8060.

The computing system 8000 can communicate with one or more external devices using network adapter 8050. The network adapter may support wired communications based on Internet, LAN, WAN, or the like, or wireless communications based on CDMA, GSM, wideband CDMA, CDMA-2000, TDMA, LTE, wireless LAN, Bluetooth, or the like.

The computing system 8000 may also include or access a variety of computing system readable media. Such media may be any available media that is accessible (locally or remotely) by a computing system (e.g., the computing system 8000), and it may include both volatile and non-volatile media, removable and non-removable media.

The memory system 8030 can include computer system readable media in the form of volatile memory, such as random access memory (RAM) and/or cache memory or others. The computing system 8000 may further include other removable/non-removable, volatile/non-volatile computer system storage media.

The memory system 8030 may include a program module (not shown) for performing (or controlling) the functions or operations described hereinabove with respect to the client device 20_{N} or the server 10 of FIGS. 1, 2A and 2B, and/or methods of FIGS. 5 and 6 according to exemplary embodiments. For example, the program module may include routines, programs, objects, components, logic, data structures, or the like, for performing particular tasks or implement particular abstract data types. The processor (e.g., 8010) of the computing system 8000 may execute instructions written in the program module to perform (or control) the functions or operations described hereinabove with respect to the client device 20_{N} or the server 10 of FIGS. 1, 2A and 2B, and/or methods of FIGS. 5 and 6. The program module may be programmed into the integrated circuits of the processor (e.g., 8010). In some embodiments, the program module may be distributed among memory system 8030 and one or more remote computer system memories (not shown).

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++ or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present disclosure has been presented for purposes of illustration and description, but is not intended to be exhaustive or limited to the present disclosure in the form disclosed. Many modifications and variations will be apparent to those of ordinary skill in the art without departing from the scope and spirit of the present disclosure. The embodiment was chosen and described in order to best explain the principles of the present disclosure and the practical application, and to enable others of ordinary skill in the art to understand the present disclosure for various embodiments with various modifications as are suited to the particular use contemplated.

While the present disclosure has been particularly shown and described with respect to preferred embodiments thereof, it will be understood by those skilled in the art that the foregoing and other changes in forms and details may be made without departing from the spirit and scope of the present disclosure. It is therefore intended that the present disclosure not be limited to the exact forms and details described and illustrated, but fall within the scope of the appended claims.

What is claimed is:

1. A system for expanding diversity of images uploaded to a network site, comprising:
a processing device; and
a memory device coupled to the processing device,
wherein the processing device is configured to perform:
identifying a location of a user device;
analyzing social media data corresponding to an area within a threshold distance of the location of the user device;
identifying at least one location of interest (LOI) of the area based on an analyzed result of the social media data;
determining whether there are one or more image gaps corresponding to the at least one LOI based on the analyzed result of the social media data; and
suggesting the user device to take one or more images of the at least one LOI, responsive to determining that there are the one or more image gaps for the at least one LOI.

2. The system of claim 1, wherein the social media data corresponding to the area comprises at least one of:
images of the area uploaded to a network site; and
other users' social interests in the area.

3. The system of claim 1, wherein the processing device identifies the at least one location of interest (LOI) of the area, responsive to determining that an amount of the social media data exceeds a predetermined threshold.

4. The system of claim 3, wherein the amount of the social media data comprises:
the number of uploaded images;
the number of comments; or
the number of demands or questions.

5. The system of claim 1, wherein the processing is further configured to perform:
limiting a scope of the social media data to be analyzed to data associated with a particular group of users.

6. The system of claim 1, wherein the processing is further configured to perform:
limiting a scope of the social media data to be analyzed to data uploaded for a particular time period.

7. The system of claim 1, wherein the processing device is further configured to perform:
determining that there are one or more image gaps for the at least one LOI, responsive to determining that no image corresponding to the at least one LOI is available in the network site.

8. The system of claim 7, wherein the processing device is further configured to perform:
suggesting the user device to take the one or more images under one or more particular conditions, responsive to determining that no image corresponding to the at least one LOI is available in the network site.

9. The system of claim 8, wherein the one or more particular conditions comprises:
perspectives from which images are taken and times at which images are taken.

10. The system of claim 8, wherein the one or more particular conditions are determined based on a level of popularity among other users.

11. A computer-implemented method for expanding diversity of images uploaded to a network site:
identifying a location of a user device;
analyzing social media data corresponding to an area within a threshold distance of the location of the user device;
identifying at least one location of interest (LOI) of the area based on an analyzed result of the social media data;
determining whether there are one or more image gaps corresponding to the at least one LOI based on the analyzed result of the social media data; and
suggesting the user device to take one or more images of the at least one LOI, responsive to determining that there are the one or more image gaps for the at least one LOI.

12. The computer-implemented method of claim 11, wherein the social media data corresponding to the area comprises at least one of:
images of the area uploaded to a network site; and
other users' social interests in the area.

13. The computer-implemented method of claim 11, wherein the at least one location of interest (LOI) of the area is identified, responsive to determining that an amount of the social media data exceeds a predetermined threshold.

14. The computer-implemented method of claim 11, wherein the determining whether there are one or more image gaps comprises:
determining that there are one or more image gaps for the at least one LOI, responsive to determining that no image corresponding to the at least one LOI is available in the network.

15. The computer-implemented method of claim 14, wherein the suggesting the user device to take the one or more images comprises:
suggesting the user device to take the one or more images under one or more particular conditions, responsive to determining that no image corresponding to the at least one LOI is available in the network site.

16. The computer-implemented method of claim 15, wherein the one or more particular conditions comprises:
perspectives from which images are taken and times at which images are taken.

17. A computer program product comprising a computer-readable storage medium having computer readable program instructions embodied therewith, the computer readable program instructions executable by at least one processor to cause a computer to perform method for expanding diversity of images uploaded to a network site, comprising:
identifying a location of a user device;
analyzing social media data corresponding to an area within a threshold distance of the location of the user device;
identifying at least one location of interest (LOI) of the area based on an analyzed result of the social media data;
determining whether there are one or more image gaps corresponding to the at least one LOI based on the analyzed result of the social media data; and
suggesting the user device to take one or more images of the at least one LOI, responsive to determining that there are the one or more image gaps for the at least one LOI.

18. The computer program product of claim 17, wherein the social media data corresponding to the area comprises at least one of:
images of the area uploaded to a network site; and
other users' social interests in the area.

19. The computer program product of claim 17, wherein the at least one location of interest (LOI) of the area is identified, responsive to determining that an amount of the social media data exceeds a predetermined threshold.

20. The computer program product of claim 17, wherein the determining whether there are one or more image gaps comprises:
determining that there are one or more image gaps for the at least one LOI, responsive to determining that no image corresponding to the at least one LOI is available in the network.
